(19) United States
(12) Patent Application Publication
(10) Pub. No.: US 2024/0357499 A1
(43) Pub. Date: Oct. 24, 2024

(54) METHOD FOR INFORMATION PROCESSING AND COMMUNICATION APPARATUS

(71) Applicant: SPREADTRUM COMMUNICATIONS (SHANGHAI) CO., LTD., Shanghai (CN)

(72) Inventors: Huayu ZHOU, Shanghai (CN); Zhenzhu LEI, Shanghai (CN); Zhengang PAN, Shanghai (CN)

(21) Appl. No.: 18/686,719

(22) PCT Filed: Dec. 30, 2021
(86) PCT No.: PCT/CN2021/143409

§ 371 Date: Feb. 26, 2024

(30) Foreign Application Priority Data
Aug. 24, 2021 (CN) 202110977697.8

(51) Int. Cl. H04W 52/02; H04W 72/0446; H04W 72/231

(52) U.S. Cl. CPC H04W 52/0235; H04W 72/0446; H04W 72/231

(57) ABSTRACT

Provided are a method for information processing and a communication apparatus. The method includes: detecting a wake-up signal, and monitoring a physical downlink control channel (PDCCH) after a first time point.

### CROSS-REFERENCE TO RELATED APPLICATION(S)

This application is a National Stage of International Application No. PCT/CN2021/143409, field Dec. 30, 2021, which claims priority to Chinese Patent Application No. 202110977697.8, filed Aug. 24, 2021, the entire disclosures of which are hereby incorporated by reference.

### TECHNICAL FIELD

This disclosure relates to the field of communication, and more particularly, to a method for information processing and a communication apparatus.

### BACKGROUND

At present, processing of a synchronization signal (SS)/physical broadcast channel (PBCH) block (SSB) burst and physical downlink control channel (PDCCH) monitoring both require use of a regular receiver (namely, a receiver used in an idle state/an inactive state/a connected state). Therefore, when a terminal device wakes up from deep sleep, power (energy) consumption is high, and power consumption in detecting a paging early indication (PEI) is also high. The overall receiver may also be referred to as a regular receiver, and has a complete radio frequency and baseband processing architecture. The overall receiver may include an SSB receiving module and a data/control receiving module with regard to division of functional modules.

For the case where the terminal device wakes up from deep sleep, in order to reduce power consumption in state transition and power consumption in signal detection, a low-power receiver (also known as low-power wake-up receiver) independent of the overall receiver may be adopted to detect a wake-up signal. After the wake-up signal is detected, the low-power receiver notifies the overall receiver, and then the overall receiver is turned on and performs measurement and data transmission and reception (for example, receive a paging message). There is a time interval between when the wake-up signal is received by the low-power receiver and when the overall receiver can perform data transmission and reception, but such time interval may increase delay in data transmission of the terminal device. Therefore, how to reduce delay in data transmission is a problem to be solved.

### SUMMARY

The disclosure provides a method for information processing and a communication apparatus, which are beneficial to reducing delay in data transmission.

In a first aspect, a method for information processing is provided in the disclosure. The method includes: detecting a wake-up signal, and monitoring a physical downlink control channel (PDCCH) after a first time point.

In the method described in the first aspect, a terminal device detects a wake-up signal, and performs PDCCH monitoring after the first time point. In this way, it is beneficial to reducing delay in data transmission and improving data transmission efficiency.

In a possible implementation, the PDCCH is monitored after the first time point as follows. Monitor a PDCCH in N slots within a 1^{st} duration that is after the first time point, where N is a positive integer; or monitor a PDCCH in a 1^{st} slot that is after the first time point.

In a possible implementation, the PDCCH is monitored after the first time point as follows. Monitor a PDCCH in W slots within first X durations that are after the first time point or a PDCCH within first X slots that are after the first time point, where X and W each are a positive integer; or monitor a PDCCH in first K slots that are after the first time point, where K is a positive integer.

In a possible implementation, the PDCCH is monitored after the first time point as follows. Monitor a PDCCH within a time window that is after the first time point.

In a possible implementation, the first time point equals to a second time point plus a first time interval. In this way, it is possible to ensure that there is a time interval for turning on an overall receiver.

In a possible implementation, the first time interval includes a second time interval plus a time interval related to a synchronization signal (SS)/physical broadcast channel (PBCH) block (SSB) period or an SS burst period. In this way, one or more SSBs or SS bursts can be processed after an overall receiver is turned on, thereby realizing time-frequency synchronization and/or measurement.

In a possible implementation, the first time interval includes a second time interval plus Y SSB periods, where Y is a positive integer. Alternatively, the first time interval includes a second time interval plus R SSB burst periods, where R is a positive integer.

In a possible implementation, the first time interval includes an interval between a third time point and a slot in which M SSBs or SS bursts closest to the third time point are located, and the third time point equals to the second time point plus a second time interval, where M is a positive integer. In this way, it is possible to ensure that there is a reference time point after an overall receiver is turned on.

In a possible implementation, the first time interval includes a second time interval plus C SSB periods and D tracking reference signal periods, where C and D each are a positive integer. In this way, a network device can send a tracking reference signal after sending the wake-up signal, so as to facilitate time-frequency synchronization and/or measurement of an overall receiver.

In a possible implementation, the first time interval includes an interval between a third time point and a slot in which E SSBs and F tracking reference signals closest to the third time point are located, and the third time point equals to the second time point plus a second time interval, where E and F each are a positive integer. In this way, it is possible to ensure that there is a reference time point after an overall receiver is turned on.

In a possible implementation, the first time interval includes a second time interval plus a period of a preamble sequence. In this way, a network device can send a preamble after sending the wake-up signal, so as to facilitate time-frequency synchronization and/or measurement of an overall receiver.

In a possible implementation, the first time interval includes an interval between a third time point and a slot in which a preamble sequence closest to the third time point is located, and the third time point equals to the second time point plus a second time interval. In this way, it is possible to ensure that there is a reference time point after an overall receiver is turned on.

In a possible implementation, the second time point is a position in a sequence of the wake-up signal. In this way, it is possible to ensure that there is a reference time point for a terminal device and a network device.

In a possible implementation, the second time point is an ending position of a sequence of the wake-up signal.

In a possible implementation, the second time interval is determined based on a capability of a terminal device.

In a possible implementation, the second time interval is zero.

In a possible implementation, the first time interval is configured via higher-layer signaling. In this way, a time interval can be configured flexibly via higher-layer signaling.

In a possible implementation, the higher-layer signaling includes system information block (SIB) signaling or non-access stratum (NAS) signaling.

In a second aspect, a method for information processing is provided in the disclosure. The method includes the following. A terminal device receives a wake-up signal, where the wake-up signal includes user equipment (UE) group information.

In the method described in the second aspect, the terminal device receives the wake-up signal, where the wake-up signal includes the UE group information. In this way, whether a UE group corresponding to a paging occasion (PO) is woken up can be determined by detecting a wake-up signal, thereby reducing unnecessary power consumption of the terminal device.

In a possible implementation, the UE group information includes a UE group identity (ID).

In a possible implementation, the UE group ID is calculated based on a UE ID, a first higher-layer parameter, and a second higher-layer parameter.

In a possible implementation the UE group ID includes a first ID and a second ID.

In a possible implementation, the first ID is calculated based on a UE ID and a first higher-layer parameter. The second ID is calculated based on the UE ID and a second higher-layer parameter. In this way, it is possible to ensure that a UE group is equivalent to a UE group corresponding to a PO.

In a possible implementation, the first ID is a remainder obtained by dividing a UE ID by a first higher-layer parameter. The second ID is a remainder obtained by dividing the UE ID by a second higher-layer parameter.

In a possible implementation, the UE group ID is a remainder obtained by dividing a UE ID by a target parameter, and the target parameter is a product of a first higher-layer parameter and a second higher-layer parameter.

In a possible implementation, the first higher layer parameter is a higher-layer parameter that is related to UE subgrouping and used for calculating a paging frame (PF).

In a possible implementation, the second higher layer parameter is a higher-layer parameter related to UE subgrouping and used for calculating a PO.

In a third aspect, a communication apparatus is provided in the disclosure. The communication apparatus includes units for implementing the method in the first aspect or the second aspect and in any possible implementation of the first aspect or the second aspect.

In a fourth aspect, a communication apparatus is provided in the disclosure. The communication apparatus includes a processor. The processor is configured to implement the method in the first aspect or the second aspect and in any possible implementation of the first aspect or the second aspect.

In a fifth aspect, a communication apparatus is provided in the disclosure. The communication apparatus includes a processor and a memory. The memory is configured to store computer executable instructions. The processor is configured to invoke the program codes from the memory to implement the method in the first aspect or the second aspect and in any possible implementation of the first aspect or the second aspect.

In a sixth aspect, a communication apparatus is provided in the disclosure. The communication apparatus includes a processor and a transceiver. The transceiver is configured to receive a signal or send a signal. The processor is configured to implement the method in the first aspect or the second aspect and in any possible implementation of the first aspect or the second aspect.

In a seventh aspect, a communication apparatus is provided in the disclosure. The communication apparatus includes a processor, a memory, and a transceiver. The transceiver is configured to receive a signal or send a signal. The memory is configured to store program codes. The processor is configured to invoke the program codes from the memory to implement the method in the first aspect or the second aspect and in any possible implementation of the first aspect or the second aspect.

In an eighth aspect, a chip is provided in the disclosure. The chip is configured to detect a wake-up signal, and is further configured to monitor a first PDCCH after a first time point.

In a ninth aspect, a chip is provided in the disclosure. The chip is configured to receive a wake-up signal, where the wake-up signal includes UE group information.

In a tenth aspect, a module device is provided in the disclosure. The module device includes a communication module, a power-supply module, a storage module, and a chip module. The power-supply module is configured to supply electric energy to the module device. The storage module is configured to store data and instructions. The communication module is configured for internal communication within the module device or communication between the module device and an external device. The chip module is configured to trigger the communication module to detect a wake-up signal, and trigger the communication module to monitor a PDCCH after a first time point.

In an eleventh aspect, the disclosure provides a module device. The module device includes a communication module, a power-supply module, a storage module, and a chip module. The power-supply module is configured to supply electric energy to the module device. The storage module is configured to store data and instructions. The communication module is configured for internal communication within the module device or communication between the module device and an external device. The chip module is configured to trigger the communication module to receive a wake-up signal, where the wake-up signal includes UE group information.

In a twelfth aspect, a computer-readable storage medium is provided in the disclosure. The computer-readable storage medium is configured to store computer-readable instructions which, when executed by a communication apparatus, are operable with the communication apparatus to implement the method in the first aspect or the second aspect and in any possible implementation of the first aspect or the second aspect.

In a thirteenth aspect, a computer program or a computer program product is provided in the disclosure. The computer program or the computer program product includes codes or instructions which, when executed by a computer, are operable with the computer to implement the method in the first aspect or the second aspect.

### BRIEF DESCRIPTION OF THE DRAWINGS

In order to describe technical solutions of embodiments of the disclosure more clearly, the following will give a brief introduction to the accompanying drawings used for describing the embodiments. Apparently, the accompanying drawings described below are merely some embodiments of the disclosure. Based on these accompanying drawings, those of ordinary skill in the art may also obtain other drawings without creative effort.

FIG. 1 is a schematic diagram of a network architecture provided in embodiments of the disclosure.

FIG. 2 is a flowchart of a method for information processing provided in embodiments of the disclosure.

FIG. 3 is a schematic diagram illustrating physical downlink control channel (PDCCH) monitoring provided in embodiments of the disclosure.

FIG. 4 is a schematic diagram illustrating another PDCCH monitoring provided in embodiments of the disclosure.

FIG. 5 is a schematic diagram illustrating another PDCCH monitoring provided in embodiments of the disclosure.

FIG. 6 is a schematic diagram illustrating another PDCCH monitoring provided in embodiments of the disclosure.

FIG. 7 is a schematic diagram illustrating another PDCCH monitoring provided in embodiments of the disclosure.

FIG. 8 is a schematic diagram illustrating a first time interval provided in embodiments of the disclosure.

FIG. 9 is a schematic diagram illustrating another first time interval provided in embodiments of the disclosure.

FIG. 10 is a schematic diagram illustrating another first time interval provided in embodiments of the disclosure.

FIG. 11 is a schematic diagram illustrating another first time interval provided in embodiments of the disclosure.

FIG. 12 is a schematic diagram illustrating another first time interval provided in embodiments of the disclosure.

FIG. 13 is a schematic diagram illustrating another first time interval provided in embodiments of the disclosure.

FIG. 14 is a schematic diagram illustrating another first time interval provided in embodiments of the disclosure.

FIG. 15 is a schematic diagram illustrating another first time interval provided in embodiments of the disclosure.

FIG. 16 is a schematic diagram illustrating another first time interval provided in embodiments of the disclosure.

FIG. 17 is a schematic diagram illustrating another first time interval provided in embodiments of the disclosure.

FIG. 18 is a schematic diagram illustrating another first time interval provided in embodiments of the disclosure.

FIG. 19 is a schematic diagram illustrating another first time interval provided in embodiments of the disclosure.

FIG. 20 is a flowchart of another method for information processing provided in embodiments of the disclosure.

FIG. 21 is a schematic structural diagram of a communication apparatus provided in embodiments of the disclosure.

FIG. 22 is a schematic structural diagram of another communication apparatus provided in embodiments of the disclosure.

FIG. 23 is a schematic structural diagram of a module device provided in embodiments of the disclosure.

### DETAILED DESCRIPTION

Technical solutions of embodiments of the disclosure will be described clearly and completely below with reference to the accompanying drawings in the embodiments of the disclosure. Apparently, the embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms used in the following embodiments of the disclosure is merely intended for describing the embodiments, rather than limiting the disclosure. The singular forms “a”, “an”, “said”, “foregoing”, “the”, and “such” used in the specification and the appended claims are intended for including the plural forms as well, unless specified otherwise in the context. In addition, it should be understood that, the term “and/or” used in the disclosure refers to and includes any or all possible combinations of one or more of the listed items.

The terms “first”, “second”, “third”, and the like in the specification of embodiments, claims of the disclosure, and above accompanying drawings are used to distinguish similar objects, and are not necessarily used to describe a particular sequence or order. It should be understood that, the terms thus used may be interchangeable where appropriate, so that the embodiments of the disclosure described herein, for example, can be implemented in a sequences other than those illustrated or described herein. In addition, the terms “include”, “comprise”, and “have” as well as variations thereof are intended to cover non-exclusive inclusion. For example, a process, method, system, product, or server including a series of steps or units is not limited to the listed steps or units, and instead, it can optionally include other steps or units that are not listed or other steps or units inherent to the process, method, product, or device.

Firstly, some terms involved in the embodiments of the disclosure will be explained to facilitate understanding of those skilled in the art.
1. Terminal device: The terminal device in the embodiments of the disclosure is a device having wireless communication functions, and may be referred to as a terminal, a user equipment (UE), a mobile station (MS), a mobile terminal (MT), an access terminal device, an in-vehicle terminal device, a terminal device in industrial control, a UE unit, a UE station, a mobile station, a remote station, a remote terminal device, a mobile device, a UE terminal device, a wireless communication device, a UE agent, a UE apparatus, or the like. The terminal device may be stationary or mobile. It should be noted that, the terminal device may support at least one wireless communication technology, for example, long term evolution (LTE), new radio (NR), and the like. For example, the terminal device may be a mobile phone, a tablet computer (pad), a desktop computer, a notebook computer, an all-in-one computer, an in-vehicle terminal, a virtual reality (VR) terminal device, an augmented reality (AR) terminal device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) telephone, a wireless local loop (WLL) station, a personal digital assistant (PDA), various devices having wireless communication functions such as a handheld device, a computing device, or other processing devices connected to a wireless modem, a wearable device, a terminal device in a future mobile communication network, or a terminal device in a future evolved public land mobile network (PLMN). In some embodiments of the disclosure, the terminal device may also be an apparatus with transceiver functions, for example, a system-on-chip (SOC). The SOC may include a chip, and may further include other discrete components, and embodiments of the disclosure are not limited in this regard.
2. Network device: The network device in the embodiments of the disclosure is a device for providing wireless communication functions for the terminal device, and may also be referred to as a radio access network (RAN) device, an access network element, or the like. The network device may support at least one wireless communication technology, such as LTE and NR. Exemplarily, the network device includes, but is not limited to, a next-generation base station (gNB), an evolved node B (eNB), and a radio network controller (RNC), a node B (NB), a base station controller (BSC), a base transceiver station (BTS), a home base station (for example, a home evolved node B, or home node B (HNB)), a baseband unit (BBU), a transmitting and receiving point (TRP), a transmitting point (TP), a mobile switching center, etc. in a 5^{th}-generation (5G) mobile communication system. The network device may also be a radio controller, a centralized unit (CU), and/or a distributed unit (DU) in a cloud radio access network (CRAN) scenario, or the network device may be a relay station, an access point, an in-vehicle device, a terminal device, a wearable device, and a network device in future mobile communications or a network device in a future evolved PLMN, etc. In some embodiments, the network device may also be a device that provides wireless communication functions for the terminal device, such as an SOC. For example, the SOC may include a chip and may further include other discrete components. In some embodiments, the network device may also communicate with an internet protocol (IP) network, for example, the Internet, a private IP network, or other data networks.
3. Synchronization signal/physical broadcast channel block (SS/PBCH block, SSB): In NR release 15 (Rel-15), an SS and a broadcast channel are transmitted as an SSB, and beam sweeping is introduced in NR Rel-15. A primary SS (PSS), a secondary SS (SSS), and a PBCH are in an SSB. Each SSB can be regarded as a resource for one beam (analog domain) during beam sweeping. Multiple SSBs can constitute an SS burst. The SS burst may also be referred to as an SSB burst. The SSB burst can be regarded as a relatively concentrated resource containing multiple beams. The SSB is repeatedly transmitted on different beams, which is a beam sweeping process. Through training of beam sweeping, the UE can sense on which beam the strongest signal is received. Time domain positions of L SSBs within a 5 millisecond (ms) window are fixed. Indexes (for example, from 0 to L−1) of the L SSBs are arranged consecutively in the time domain positions. Transmission time of an SSB within the 5 ms window is fixed and the index thereof is also fixed.

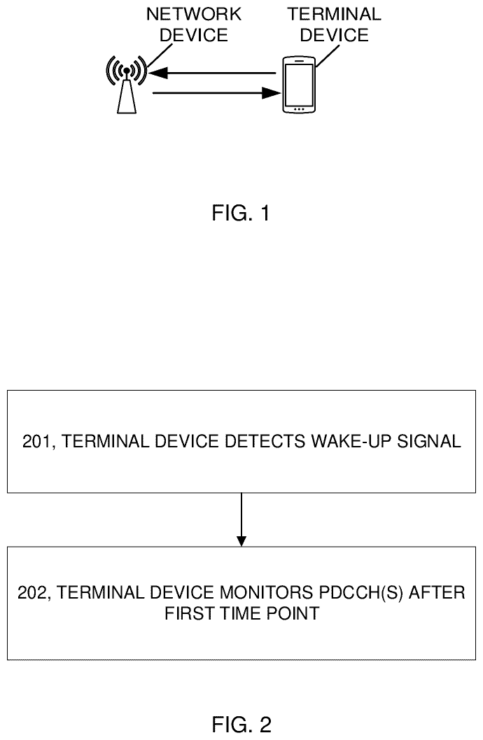

Embodiments of the disclosure may be applied to a network architecture illustrated in FIG. 1. The network architecture illustrated in FIG. 1 is a network architecture of a wireless communication system. The network architecture usually includes a terminal device and a network device. The quantities and forms of various devices do not constitute limitation on embodiments of the disclosure. The network device may be a base station (BS). The base station may provide communication service to multiple terminal devices, and multiple base stations may provide communication service to the same terminal device.

It should be noted that, at present, processing of an SSB burst and physical downlink control channel (PDCCH) monitoring both require use of an overall receiver (namely, a receiver used in an idle state/an inactive state/a connected state). Therefore, when the terminal device wakes up from sleep, power (energy) consumption in such conversion is high, and power consumption in detecting a paging-related PDCCH or paging early indication (PEI) is also high. The overall receiver may also be referred to as a regular receiver, and has a complete radio frequency and baseband processing architecture. The overall receiver may include an SSB receiving module and a data/control receiving module with regard to division of functional modules.

For the case where the terminal device wakes up from deep sleep, in order to reduce power consumption in such conversion and power consumption in signal detection, a low-power receiver independent of the overall receiver may be adopted to detect a wake-up signal. After the wake-up signal is detected, the low-power receiver notifies the overall receiver, and then the overall receiver is turned on and performs measurement and data transmission and reception (for example, receive a paging message). There is a time interval between when the wake-up signal is received by the low-power receiver and when the overall receiver can perform data transmission and reception, but such time interval may increase delay in data transmission of the terminal device. Therefore, how to reduce delay in data transmission is a problem to be solved.

In order to reduce delay in data transmission and improve data transmission efficiency, embodiments of the disclosure provide a method for information processing. In order for better understanding of the method for information processing provided in embodiments of the disclosure, the method for information processing will be described in detail below.

Referring to FIG. 2, FIG. 2 is a flowchart of a method for information processing provided in embodiments of the disclosure. The method for information processing includes step 201 and step 202. An execution entity for the method illustrated in FIG. 2 may be a terminal device (for example, that as illustrated in FIG. 1), or may be a chip in the terminal device. Exemplarily, the execution entity for the method illustrated in FIG. 2 is a terminal device.

201, a terminal device detects a wake-up signal.

In embodiments of the disclosure, the terminal device may receive the wake-up signal sent by a network device, where the wake-up signal is used for waking up the terminal device to perform PDCCH monitoring.

Optionally, the terminal device is configured with a low-power receiver and an overall receiver, where the low-power receiver is configured to detect the wake-up signal. After the wake-up signal is detected by the low-power receiver, the low-power receiver notifies the overall receiver, and then the overall receiver is turned on and performs PDCCH monitoring.

Optionally, the wake-up signal may include UE group information. By detecting the UE group information in the wake-up signal, the terminal device may determine whether to wake up, thereby reducing power consumption of the terminal device.

202, the terminal device monitors a PDCCH(s) after a first time point.

In embodiments of the disclosure, since a PDCCH is configured based on a search space set (SSS) and is periodic, after the first time point is agreed between the network device and the terminal device, the network device may start sending a PDCCH and the terminal device may start monitoring the PDCCH. The PDCCH may be a paging PDCCH or a paging indication PDCCH, which is not limited herein. In this way, it is beneficial to reducing delay in data transmission and improving data transmission efficiency.

The term “monitoring a PDCCH” in embodiments of the disclosure is equivalent to “monitoring a PDCCH monitoring occasion”.

In a possible implementation, the terminal device monitors the PDCCH after the first time point as follows. Monitor a PDCCH in N slots within a 1^{st} duration that is after the first time point, where N is a positive integer. In this way, the terminal device may need to monitor a PDCCH(s) in multiple slots within the 1^{st} duration that is after the first time point, thereby improving reliability of PDCCH monitoring.

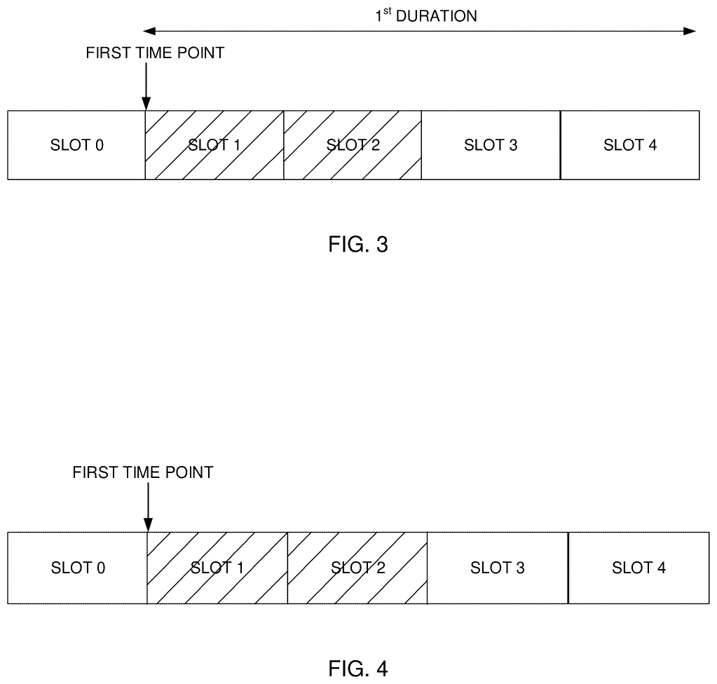

Exemplarily, as illustrated in FIG. 3, FIG. 3 is a schematic diagram illustrating PDCCH monitoring provided in embodiments of the disclosure. In this example, N=4, the first time point is a start time of slot 1, and the duration is four slots. Accordingly, the 1^{st} duration includes slot 1˜slot 4. The terminal device monitors a PDCCH within the 1^{st} duration that is after the first time point, that is, monitors a PDCCH(s) in slot 1˜slot 4.

In a possible implementation, the terminal device monitors the PDCCH after the first time point as follows. Monitor a PDCCH in a 1^{st} slot that is after the first time point. In this way, the terminal device only needs to monitor the PDCCH in the 1^{st} slot that is after the first time point, thereby reducing PDCCH monitoring of the terminal device.

In a possible implementation, the terminal device monitors the PDCCH after the first time point as follows. Monitor a PDCCH in a 1^{st} slot that is after the first time point if the duration is not configured. In this way, if no duration is configured, the terminal device only needs to monitor the PDCCH in the 1^{st} slot that is after the first time point, and as such, a base station can control the terminal device to reduce PDCCH monitoring of the terminal device.

Exemplarily, as illustrated in FIG. 4, FIG. 4 is a schematic diagram illustrating another PDCCH monitoring provided in embodiments of the disclosure. In this example, the first time point is a start time of slot 1, and the duration is not configured. The terminal device monitors the PDCCH in the 1^{st} slot that is after the first time point, that is, monitors a PDCCH in slot 1.

In a possible implementation, the terminal device monitors the PDCCH after the first time point as follows. Monitor a PDCCH in first T slots within a 1^{st} duration that is after the first time point, where T is the number of slots corresponding to a duration, and T is a positive integer. In this case, T is less than or equal to the number of slots in the duration. In this way, the terminal device may need to monitor the PDCCH in the first T slots within the 1^{st} duration that is after the first time point, which is conducive to reliability of PDCCH monitoring and flexibility of control by a base station (the value of T may be set).

Exemplarily, as illustrated in FIG. 3, FIG. 3 is a schematic diagram illustrating another PDCCH monitoring provided in embodiments of the disclosure. In this example, the first time point is a start time of slot 1, the duration is four slots, and T=2. The terminal device monitors a PDCCH(s) in the first two slots that are after the first time point, that is, monitors a PDCCH(s) in slot 1 and slot 2.

In a possible implementation, the terminal device monitors the PDCCH after the first time point as follows. Monitor a PDCCH in first K slots that are after the first time point, where K is a positive integer. In this way, the terminal device may need to monitor the PDCCH in the first K slots that are after the first time point, which is conducive to reliability of PDCCH monitoring and flexibility of control by a base station (the value of K may be set).

In a possible implementation, the terminal device monitors the PDCCH after the first time point as follows. Monitor a PDCCH in first H slots that are after the first time point if no duration is configured, where H is a positive integer. In this way, if no duration is configured, the terminal device may need to monitor the PDCCH in the first H slots that are after the first time point, which is conducive to reliability of PDCCH monitoring and flexibility of control by a base station (the value of H may be set).

Exemplarily, as illustrated in FIG. 4, FIG. 4 is a schematic diagram illustrating another PDCCH monitoring provided in embodiments of the disclosure. In this example, H=2, the first time point is a start time of slot 1, and no duration is configured. The terminal device monitors a PDCCH(s) in the first two slots that are after the first time point, that is, monitors a PDCCH(s) in slot 1 and slot 2.

The duration represents a duration of a PDCCH, or a duration of a PDCCH monitoring occasion, or a duration of an SSS for a PDCCH, or a slot-level duration of an SSS for a PDCCH. Each duration includes one or more slots, and a PDCCH in each slot occupies one or more symbols. The network device may configure for the terminal device a duration corresponding to an SSS for the terminal device via a higher-layer parameter (duration) in the SSS, that is, the duration may be a parameter in the SSS.

In a possible implementation, the terminal device monitors the PDCCH after the first time point as follows. Monitor a PDCCH within first X durations that are after the first time point, where X is a positive integer. In this way, the terminal device may need to monitor the PDCCH within the first X durations that are after the first time point (the number of slots therein is the number of slots in one duration multiplied by X), which is conducive to reliability of PDCCH monitoring.

In a possible implementation, the terminal device monitors the PDCCH after the first time point as follows. Monitor a PDCCH in first X PDCCH periods that are after the first time point, where X is a positive integer. In this way, the terminal device may need to monitor the PDCCH in the first X PDCCH periods that are after the first time point (the number of slots therein is the number of slots in one duration multiplied by X), which is conducive to reliability of PDCCH monitoring.

In a possible implementation, the terminal device monitors the PDCCH after the first time point as follows. Monitor a PDCCH in W slots within first X durations that are after the first time point, where X and Weach are a positive integer, and W is less than or equal to the number of slots in one duration multiplied by X. In this way, the terminal device may need to monitor a PDCCH(s) in multiple slots within the first X durations that are after the first time point, thereby improving reliability of PDCCH monitoring.

In a possible implementation, the terminal device monitors the PDCCH after the first time point as follows. Monitor a PDCCH in W slots within first X PDCCH periods that are after the first time point, where X and W each are a positive integer, and W is less than or equal to the number of slots in one duration multiplied by X. In this way, the terminal device may need to monitor a PDCCH(s) in multiple slots within the first X PDCCH periods that are after the first time point, thereby improving reliability of PDCCH monitoring.

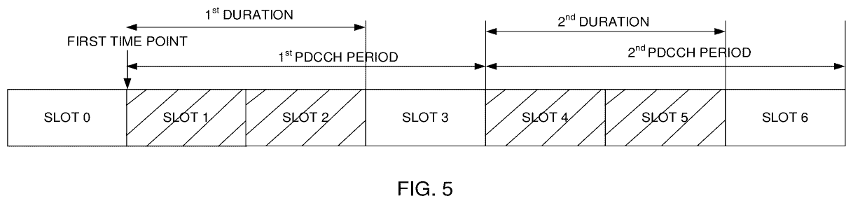

Exemplarily, as illustrated in FIG. 5, FIG. 5 is a schematic diagram illustrating another PDCCH monitoring provided in embodiments of the disclosure. In this example, the PDCCH period is three slots, the first time point is a start time of slot 1, and a duration is two slots. Accordingly, if X=2 (W=2*2=4), a 1^{st} duration includes slot 1 and slot 2 and a 2^{nd} duration includes slot 4 and slot 5. The terminal device monitors a PDCCH(s) in the 1^{st} duration and the 2^{nd} duration that are after the first time point, that is, a PDCCH(s) in slot 1, slot 2, slot 4, and slot 5.

In a possible implementation, the terminal device monitors the PDCCH after the first time point as follows. Monitor a PDCCH in first P PDCCH periods that are after the first time point, where P is a positive integer. In this way, the terminal device may need to monitor the PDCCH in the first P PDCCH periods that are after the first time point, which improves reliability of PDCCH monitoring and improves flexibility of control by a base station (the value of P may be set).

In a possible implementation, the terminal device monitors the PDCCH after the first time point as follows. Monitor a PDCCH in first F PDCCH periods that are after the first time point if no duration is configured, where F is a positive integer. In this way, the terminal device may need to monitor the PDCCH in the first F PDCCH periods that are after the first time point, which improves reliability of PDCCH monitoring and improves flexibility of control by a base station (the value of F may be set).

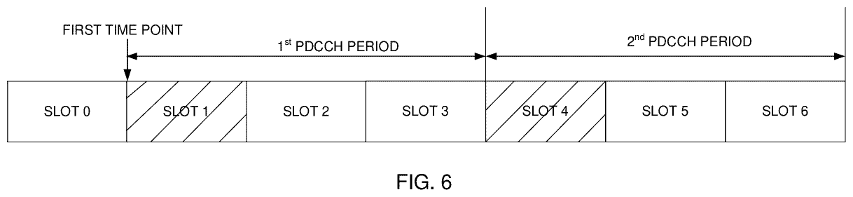

Exemplarily, as illustrated in FIG. 6, FIG. 6 is a schematic diagram illustrating another PDCCH monitoring provided in embodiments of the disclosure. In this example, F=2, the PDCCH period is 3 slots, the first time point is a start time of slot 1, and no duration is not configured. The terminal device monitors a PDCCH(s) in first two PDCCH periods that are after the first time point, that is, a PDCCH(s) in slot 1 and slot 4.

In a possible implementation, the terminal device monitors the PDCCH after the first time point as follows. Monitor a PDCCH within a time window that is after the first time point. The time window is a fixed time range configured for the terminal device.

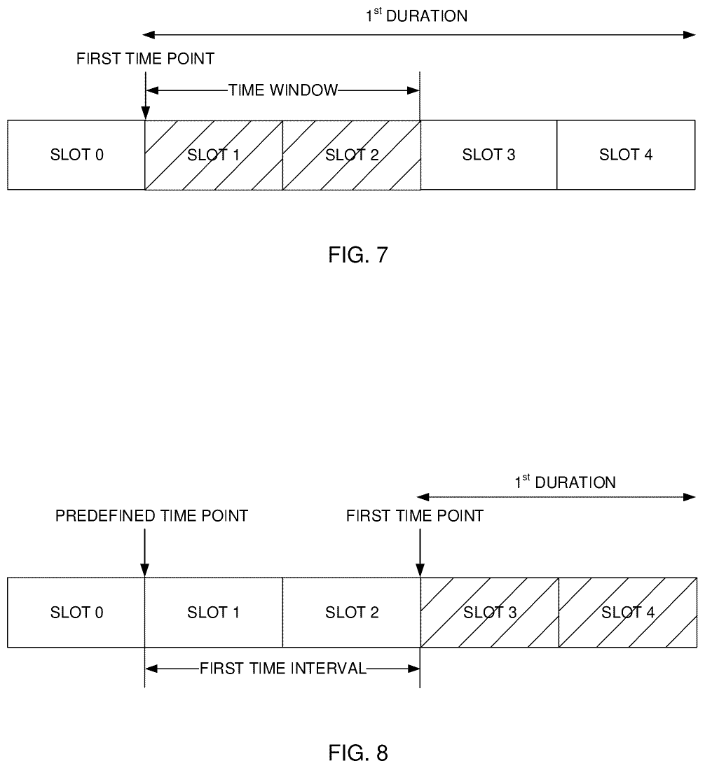

Exemplarily, as illustrated in FIG. 7, FIG. 7 is a schematic diagram illustrating another PDCCH monitoring provided in embodiments of the disclosure. In this example, the first time point is a start time of slot 1, and the length of the time window is two slots. The terminal device monitors the PDCCH in the time window that is after the first time point, that is, monitors a PDCCH(s) in slot 1 and slot 2 within the time window.

In a possible implementation, the first time point equals to a predefined time point (exemplarily, may be referred to as a second time point) plus a first time interval. i.e.:

$$First time point = predefined time point + firt time interval$$

In other words, the first time interval is a time interval between the first time point and the predefined time point. Since the low-power receiver triggers turn-on of the overall receiver after the wake-up signal is detected by the low-power receiver at the predefined time point and a time interval is needed to turn on the overall receiver, the first time point equals to the predefined time point plus the first time interval, which ensures that the time interval for turning on the overall receiver is long enough, and the overall receiver has enough time to be turned on.

Exemplarily, as illustrated in FIG. 8, FIG. 8 is a schematic diagram illustrating the first time interval provided in embodiments of the disclosure. In this example, the predefined time point is a start time of slot 1, the first time interval includes two slots, a duration includes two slots, and the first time point equals to the predefined time point plus the first time interval (the first time interval is a time interval between the predefined time point and the first time point). The terminal device monitors a PDCCH within the 1^{st} duration that is after the first time point, that is, monitors a PDCCH(s) in slot 3 and slot 4.

In a possible implementation, the first time interval includes a second time interval. The second time interval may be pre-defined in a protocol, or may be configured by the network device, or may be determined by the terminal device based on some policy or algorithm. Since the low-power receiver triggers turn-on of the overall receiver after the wake-up signal is detected by the low-power receiver at the predefined time point and a time interval is needed to turn on the overall receiver, the time for such procedure is included in the second time interval. The terminal device needs to have a capability of turning on the overall receiver within the second time interval, where the capability may be agreed between the network device and the terminal device. i.e.:

$$\begin{matrix}First time point = predefined time point + first time interval \\ = predefined time point + second time interval\end{matrix}$$

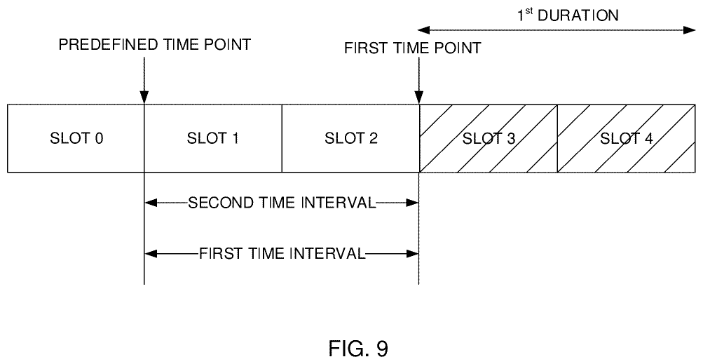

Exemplarily, as illustrated in FIG. 9, FIG. 9 is a schematic diagram illustrating another first time interval provided in embodiments of the disclosure. In this example, the predefined time point is a start time of slot 1, a duration includes two slots, the first time interval includes two slots, the first time point equals to the predefined time point plus the first time interval (the first time interval is a time interval between the predefined time point and the first time point), and the first time interval may be the second time interval. The terminal device monitors a PDCCH within the 1^{st} duration that is after the first time point, that is, monitors a PDCCH(s) within slot 3 and slot 4.

In a possible implementation, the first time interval includes a time interval related to an SSB period or an SS burst period. The SSB period or the SS burst period may refer to a period of a half frame (5 milliseconds (ms) in length) used for transmitting an SSB or an SS burst. In this way, one or more SSBs or SS bursts can be processed by the overall receiver after the overall receiver is turned on, so as to realize time-frequency synchronization and/or measurement. i.e.:

$$\begin{matrix}First time point = predefined time point + first time interval \\ = predefined time point + time interval related \\ to SSB period or SS burst period\end{matrix}$$

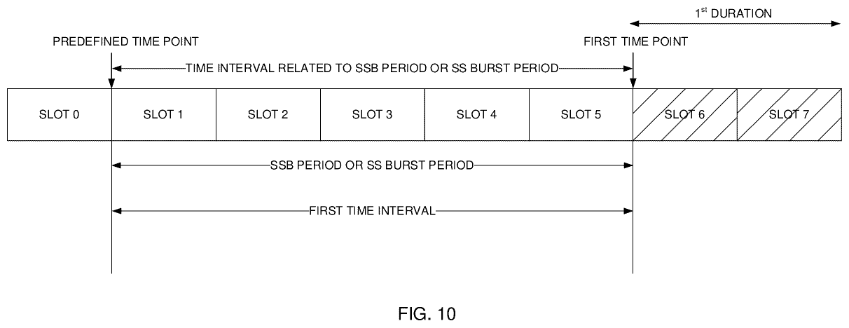

Exemplarily, as illustrated in FIG. 10, FIG. 10 is a schematic diagram illustrating another first time interval provided in embodiments of the disclosure. In this example, the predefined time point is a start time of slot 1, a duration includes two slots, the first time interval includes five slots, the first time point equals to the predefined time point plus the first time interval (the first time interval is a time interval between the predefined time point and the first time point), and the first time interval may include the time interval (which is exemplarily five slots) related to an SSB period or an SS burst period. The terminal device monitors a PDCCH within the 1^{st} duration that is after the first time point, that is, monitors a PDCCH(s) in slot 6 and slot 7.

Optionally, the first time interval includes Z SSB periods or SSB burst periods, where Z is a positive integer. i.e.:

$$\begin{matrix}First time point = predefined time point + first time interval \\ = predefined time point + Z SSB periods or \\ SS burst periods\end{matrix}$$

Exemplarily, as illustrated in FIG. 10, FIG. 10 is a schematic diagram illustrating another first time interval provided in embodiments of the disclosure. In this example, the predefined time point is a start time of slot 1, a duration includes two slots, the first time interval includes five slots, the first time point equals the predefined time point plus the first time interval (the first time interval is a time interval between the predefined time point and the first time point), and Z=1, that is, the first time interval includes one SSB period or SS burst period (which is exemplarily five slots). The terminal device monitors a PDCCH within the 1^{st} duration that is after the first time point, that is, monitors a PDCCH(s) in slot 6 and slot 7.

In a possible implementation, the first time interval includes a second time interval plus a time interval related to an SSB period or an SS burst period. The second time interval may be pre-defined in a protocol, or may be configured by the network device, or may be determined by the terminal device based on some policy or algorithm. i.e.:

$$\begin{matrix}First time point = predefined time point + first time interval \\ = predefined time point + ( second time interval + time \\ interval related to SSB period or SS burst period )\end{matrix}$$

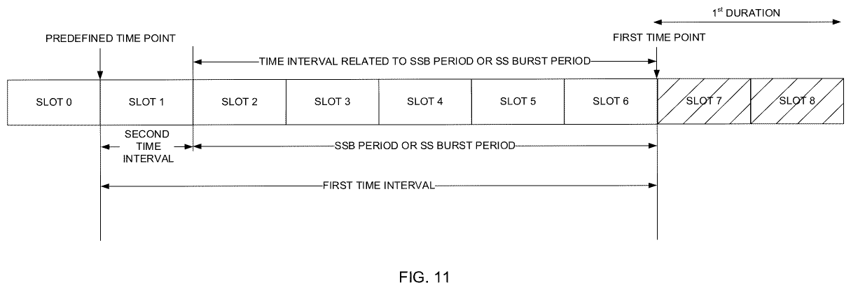

Exemplarily, as illustrated in FIG. 11, FIG. 11 is a schematic diagram illustrating another first time interval provided in embodiments of the disclosure. In this example, the predefined time point is a start time of slot 1, a duration includes two slots, the first time interval includes six slots, the first time point equals to the predefined time point plus the first time interval (the first time interval is a time interval between the predefined time point and the first time point), and the first time interval may include the second time interval (which is exemplarily one slot) plus the time interval (which is exemplarily five slots) related to an SSB period or an SS burst period. The terminal device monitors a PDCCH within the 1^{st} duration that is after the first time point, that is, monitors a PDCCH(s) in slot 7 and slot 8.

In a possible implementation, the first time interval includes a second time interval plus Y SSB periods, where Y is a positive integer. Alternatively, the first time interval includes a second time interval plus R SSB burst periods, where R is a positive integer. The second time interval may be pre-defined in a protocol, or may be configured by the network device, or may be determined by the terminal device based on some policy or algorithm. In this way, one or more SSBs or SS burst periods can be processed by the overall receiver after the overall receiver is turned on, so as to realize time-frequency synchronization and/or measurement.

$$\begin{matrix}First time point = predefined time point + first time interval \\ = predefined time point + ( second time interval + \\ Y SSB periods or R SS burst periods )\end{matrix}$$

Exemplarily, as illustrated in FIG. 11, FIG. 11 is a schematic diagram illustrating another first time interval provided in embodiments of the disclosure. In this example, the predefined time point is a start time of slot 1, a duration includes two slots, the first time interval includes six slots, the first time point equals to the predefined time point plus the first time interval (the first time interval is a time interval between the predefined time point and the first time point), and Y=1, that is, the first time interval includes the second time interval (exemplarily one slot) plus an SSB period or an SS burst period (exemplarily five slots). The terminal device monitors a PDCCH within a 1^{st} duration that is after the first time point, that is, monitors a PDCCH(s) in slot 7 and slot 8.

In a possible implementation, the first time interval includes an interval between a reference time point and a slot in which M SSBs or SS bursts closest to the reference time point (exemplarily, may be referred to as a third time point) are located, where M is a positive integer. The reference time point equals to the predefined time point plus a second time interval. The M SSBs or SS bursts closest to the reference time point may be first M SSBs or SS bursts after the reference time point. The second time interval may be pre-defined in a protocol, or may be configured by the network device, or may be determined by the terminal device based on some policy or algorithm. In this way, it is possible to ensure that there is a reference time point after the overall receiver is turned on.

$$\begin{matrix}First time point = reference time point + first time interval \\ = reference time point + interval between \\ reference time point and slot in which \\ M SSBs or SS bursts closest to reference \\ time point are located\end{matrix}$$

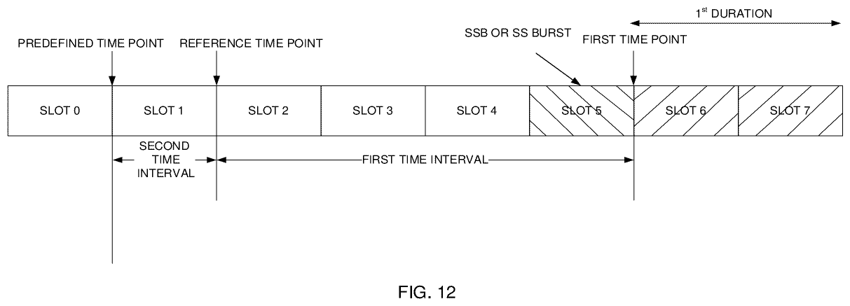

Exemplarily, as illustrated in FIG. 12, FIG. 12 is a schematic diagram illustrating another first time interval provided in embodiments of the disclosure. In this example, the predefined time point is a start time of slot 1, a duration includes two slots, the first time interval includes four slots, the first time point equals to the reference time point plus the first time interval (the first time interval is a time interval between the reference time point and the first time point), the reference time point equals to the predefined time point plus the second time interval (the second time interval is a time interval (which is exemplarily one slot) between the reference time point and the predefined time point), and M=1, that is, the first time interval includes an interval between the reference time point and a slot in which the one SSB or SS burst closest to the reference time point is located (the interval is exemplarily four slots, that is, the slot in which the SSB or SS burst closest to the reference time point is located is slot 5). The terminal device monitors a PDCCH within the 1^{st} duration that is after the first time point, that is, monitors a PDCCH(s) in slot 6 and slot 7. Here, the slot in which the M SSBs or SS bursts closest to the reference time point are located means: a slot in which an ending position of the M SSBs or SS bursts closest to the reference time point is located, or a slot in which an ending position of transmission of the M SSBs or SS bursts closest to the reference time point is located, or a slot for an ending position of a half-frame in which the M SSBs or SS bursts closest to the reference time point are located, or a slot in which an ending position of a half-frame used for transmitting the M SSBs or SS bursts closest to the reference time point is located.

In a possible implementation, the first time interval includes A SSB periods and B tracking reference signal periods, where A and Beach are a positive integer. In this way, the network device can send a tracking reference signal after sending the wake-up signal, so as to facilitate time-frequency synchronization and/or measurement of the overall receiver. i.e.:

$$\begin{matrix}First time point = predefined time point + first time interval \\ = predefined time point + A SSB periods + \\ B tracking reference signal periods\end{matrix}$$

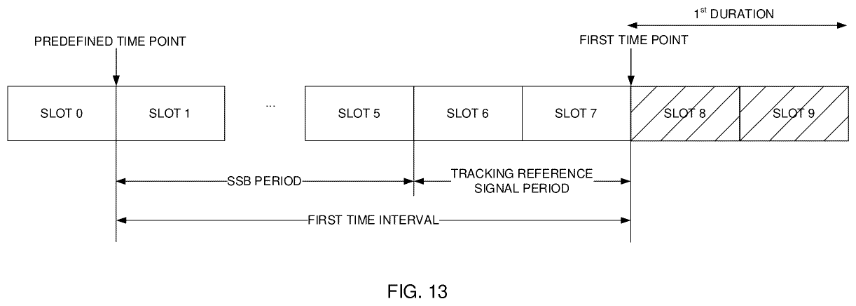

Exemplarily, as illustrated in FIG. 13, FIG. 13 is a schematic diagram illustrating another first time interval provided in embodiments of the disclosure. In this example, A=1, B=1, the predefined time point is a start time of slot 1, a duration includes two slots, the first time interval includes seven slots, the first time point equals to the predefined time point plus the first time interval (the first time interval is a time interval between the predefined time point and the first time point), and the first time interval includes a second time interval (exemplarily one slot) plus one SSB period (exemplarily five slots) and one tracking reference signal period (exemplarily two slots). The terminal device monitors a PDCCH within the 1^{st} duration that is after the first time point, that is, monitors a PDCCH(s) in slot 8 and slot 9.

In a possible implementation, the first time interval includes a second time interval plus C SSB periods and D tracking reference signal periods, where C and D each are a positive integer. The second time interval may be pre-defined in a protocol, or may be configured by the network device, or may be determined by the terminal device based on some policy or algorithm. i.e.:

$$\begin{matrix}First time point = predefined time point + first time interval \\ = predefined time point + ( second time interval + \\ C SSB periods + D tracking reference signal periods )\end{matrix}$$

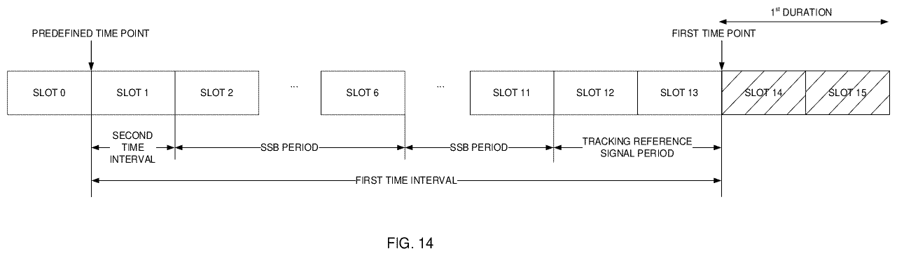

Exemplarily, as illustrated in FIG. 14, FIG. 14 is a schematic diagram illustrating another first time interval provided in embodiments of the disclosure. In this example, C=2, D=1, the predefined time point is a start time of slot 1, a duration includes two slots, the first time interval includes 13 slots, the first time point equals to the predefined time point plus the first time interval (the first time interval is a time interval between the predefined time point and the first time point), and the first time interval includes the second time interval (exemplarily one slot) plus two SSB periods (exemplarily, each SSB period includes five slots) and one tracking reference signal period (exemplarily two slots). The terminal device monitors a PDCCH within the 1^{st} duration that is after the first time point, that is, monitors a PDCCH(s) in slot 14 and slot 15.

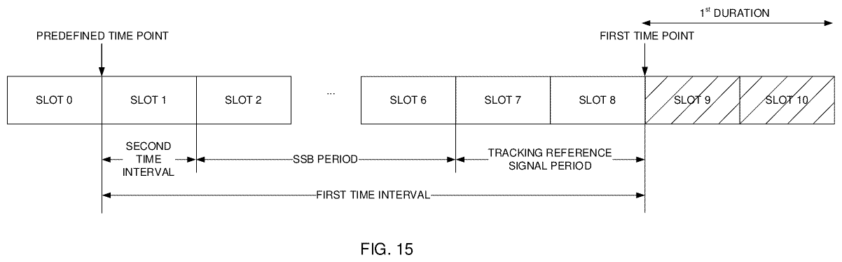

For another example, as illustrated in FIG. 15, FIG. 15 is a schematic diagram illustrating another first time interval provided in embodiments of the disclosure. In this example, C=1, D=1, the predefined time point is a start time of slot 1, a duration includes two slots, the first time interval includes eight slots, the first time point equals to the predefined time point plus the first time interval (the first time interval is a time interval between the predefined time point and the first time point), and the first time interval includes the second time interval (exemplarily one slot) plus one SSB period (exemplarily five slots) and one tracking reference signal period (exemplarily two slots). The terminal device monitors a PDCCH within the 1^{st} duration that is after the first time point, that is, monitors a PDCCH(s) in slot 9 and slot 10.

In a possible implementation, the first time interval includes an interval between a reference time point and a slot in which E SSBs and F tracking reference signals closest to the reference time point are located, where E and F each are a positive integer, and the reference time point equals to a predefined time point plus a second time interval. The E SSBs and the F tracking reference signals closest to the reference time point may be first E SSBs and F tracking reference signals after the reference time point. The second time interval may be pre-defined in a protocol, or may be configured by the network device, or may be determined by the terminal device based on some policy or algorithm. In this way, with such reference time point, it is possible to ensure that there is a reference time point after the overall receiver is turned on. i.e.:

$$\begin{matrix}First time point = reference time point + first time interval \\ = reference time point + ( time interval between \\ reference time point and slot in which E SSBs and \\ F tracking reference signals closest to reference \\ time point are located )\end{matrix}$$

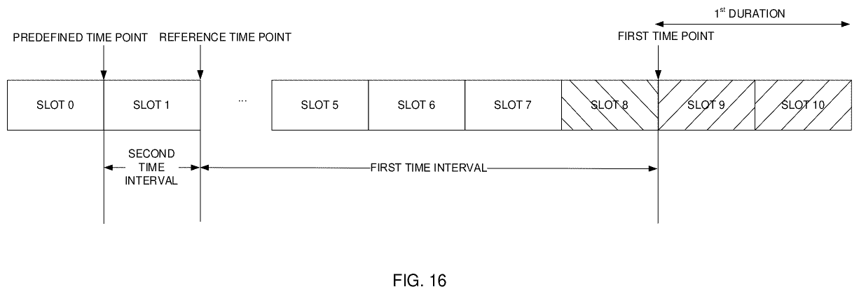

Exemplarily, as illustrated in FIG. 16, FIG. 16 is a schematic diagram illustrating another first time interval provided in embodiments of the disclosure. In this example, the predefined time point is a start time of slot 1, a duration includes two slots, the first time interval includes seven slots, the first time point equals to the reference time point plus the first time interval (the first time interval is a time interval between the reference time point and the first time point), the reference time point equals to the predefined time point plus the second time interval (the second time interval is a time interval (exemplarily one slot) between the reference time point and the predefined time point), E=1, and F=1, that is, the first time interval includes an interval between the reference time point and a slot in which the one SSB and the one tracking reference signal closest to the reference time point are located (the interval is exemplarily seven slots, that is, the slot in which the SSB and the tracking reference signal closest to the reference time point are located is slot 8). The terminal device monitors a PDCCH within the 1^{st} duration that is after the first time point, that is, monitors a PDCCH(s) in slot 9 and slot 10. Here, the slot in which the E SSBs and the F tracking reference signals closest to the reference time point are located means: a slot in which an ending position of the E SSBs and the F tracking reference signals closest to the reference time point is located, or a slot which an ending position of transmission of the E SSBs and the F tracking reference signals closest to the reference time point is located, or a slot for an ending position of a half frame in which the E SSBs and the Ftracking reference signals closest to the reference time point are located, or a slot in which an ending position of a half-frame used for transmitting the E SSBs and the F tracking reference signals closest to the reference time point is located. In this implementation, the SSB is equivalent to an SS burst. The ending position of the E SSBs and the F tracking reference signals may be an ending position of the E SSBs and the F tracking reference signals as a whole. The ending position of the transmission of the E SSBs and the F tracking reference signals may be an ending position of transmission of the E SSBs and the F tracking reference signals as a whole. The ending position of the half-frame in which the E SSBs and the F tracking reference signals are located may be an ending position of a half-frame in which the E SSBs and the F tracking reference signals as a whole are located. The ending position of the half-frame used for transmitting the E SSBs and the F tracking reference signals may be an ending position of a half-frame used for transmitting the ESSBs and the F tracking reference signals as a whole.

In a possible implementation, the first time interval includes a period of a preamble sequence. In this way, the network device can send a preamble after sending the wake-up signal, so as to facilitate time-frequency synchronization and/or measurement of the overall receiver. i.e.:

$$\begin{matrix}First time point = predefined time point + first time interval \\ = predefined time point + period of preamble sequence\end{matrix}$$

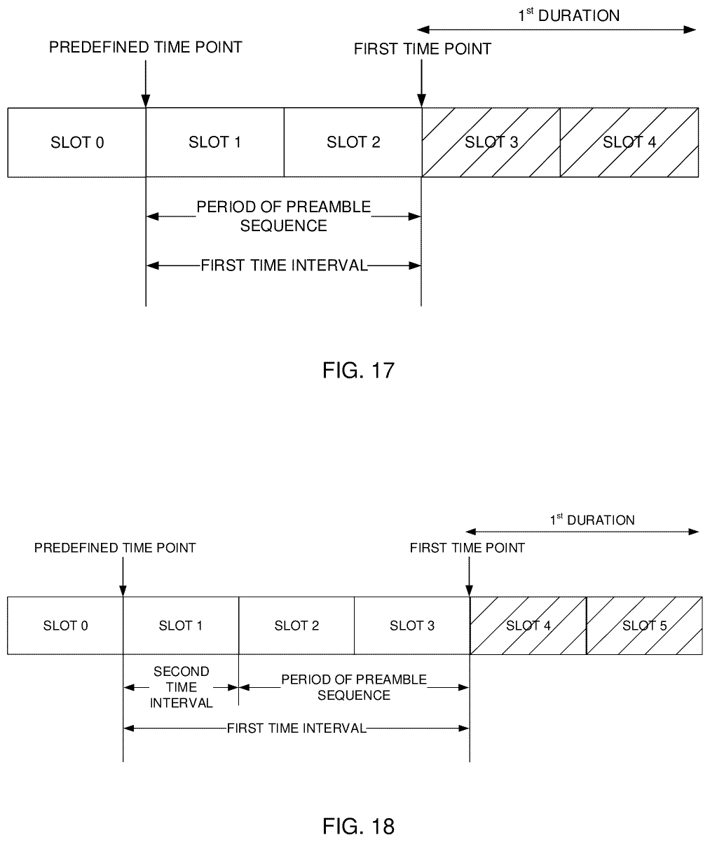

Exemplarily, as illustrated in FIG. 17, FIG. 17 is a schematic diagram illustrating another first time interval provided in embodiments of the disclosure. In this example, the predefined time point is a start time of slot 1, a duration includes two slots, the first time interval includes two slots, the first time point equals to the predefined time point plus the first time interval (the first time interval is a time interval between the predefined time point and the first time point), and the first time interval includes the period of the preamble sequence (exemplarily two slots). The terminal device monitors a PDCCH within the 1^{st} duration that is after the first time point, that is, monitors a PDCCH(s) in slot 3 and slot 4.

In a possible implementation, the first time interval includes a second time interval plus a period of a preamble sequence. The second time interval may be pre-defined in a protocol, or may be configured by the network device, or may be determined by the terminal device based on some policy or algorithm. The preamble sequence is a special signal in a frame structure, is characterized by short time, and can facilitate quick time-frequency synchronization and/or measurement of the overall receiver. i.e.:

$$\begin{matrix}First time point = predefined time point + first time interval \\ = predefined time point + ( second time interval + \\ period of preamble sequence )\end{matrix}$$

Exemplarily, as illustrated in FIG. 18, FIG. 18 is a schematic diagram illustrating another first time interval provided in embodiments of the disclosure. In this example, the predefined time point is a start time of slot 1, a duration includes two slots, and the first time interval includes three slots, the first time point equals to the predefined time point plus the first time interval (the first time interval is a time interval between the predefined time point and the first time point), and the first time interval includes the second time interval (exemplarily one slot) plus the period of the preamble sequence (exemplarily two slots). The terminal device monitors a PDCCH within the 1^{st} duration that is after the first time point, that is, monitors a PDCCH(s) in slot 4 and slot 5.

In a possible implementation, the first time interval includes an interval between a reference time point and a slot in which a preamble sequence closest to the reference time point is located, where the reference time point equals to a predefined time point and a second time interval. The second time interval may be pre-defined in a protocol, or may be configured by the network device, or may be determined by the terminal device based on some policy or algorithm. In this way, with such reference time point, it is possible to ensure that there is a reference time point after the overall receiver is turned on. i.e.:

$$\begin{matrix}First time point = reference time point + first time interval \\ = reference time point + ( interval between reference \\ time point and slot in which preamble sequence \\ closest to reference time point is located )\end{matrix}$$

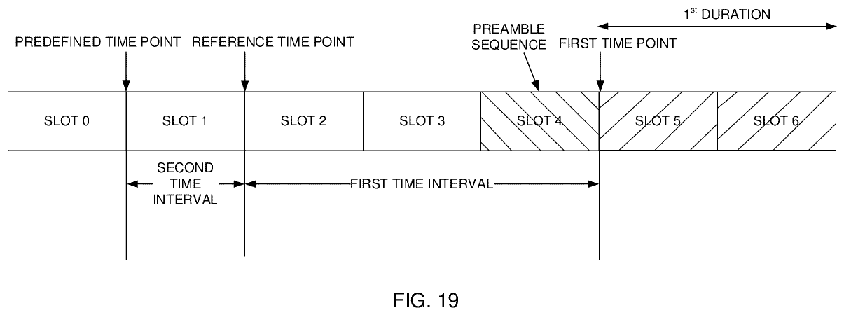

Exemplarily, as illustrated in FIG. 19, FIG. 19 is a schematic diagram illustrating another first time interval provided in embodiments of the disclosure. In this example, the predefined time point is a start time of slot 1, a duration includes two slots, the first time interval includes three slots, the first time point equals to the reference time point plus the first time interval (the first time interval is a time interval between the reference time point and the first time point), the reference time point equals to the predefined time point plus the second time interval (the second time interval is a time interval (exemplarily one slot) between the reference time point and the predefined time point), and the first time interval includes an interval between the reference time point and the slot in which the preamble sequence closest to the reference time point is located (the interval is exemplarily three slots, that is, the slot in which the preamble sequence closest to the reference time point is located is slot 4). The terminal device monitors a PDCCH within the 1^{st} duration that is after the first time point, that is, monitors a PDCCH(s) in slot 5 and slot 6. Here, the slot in which the preamble sequence closest to the reference time point is located means: a slot in which an ending position of the preamble sequence closest to the reference time point is located, or a slot in which an ending position of transmission of the preamble sequence closest to the reference time point is located, or a slot for an ending position of a half-frame in which the preamble sequence closest to the reference time point is located, or a slot in which an ending position of a half-frame used for transmitting the preamble sequence closest to the reference time point is located.

In a possible implementation, the second time interval is zero. That is, in the possible manner described above, there may be no second time interval included in the first time interval.

In a possible implementation, the predefined time point is a position in a sequence of the wake-up signal. Optionally, the predefined time point is an ending position of the sequence of the wake-up signal. In this way, it is possible to ensure that there is a reference time point for the terminal device and the network device.

In a possible implementation, the second time interval is determined based on a capability of the terminal device. Since the time for a procedure in which the low-power receiver triggers turn-on of the overall receiver depends on the capability of the terminal device, the second time interval may be determined based on the capability of the terminal device.

In a possible implementation, the first time interval is configured via higher-layer signaling. Optionally, the higher-layer signaling includes system information block (SIB) signaling or non-access stratum (NAS) signaling. In this way, a time interval can be configured flexibly via higher-layer signaling, where the time interval includes (is greater than or equal to) a pre-defined time interval. It should be noted that, the network device may configure the first time interval via SIB signaling (broadcast mode), or the network device may configure the first time interval via NAS signaling (unicast mode or dedicated pilot mode).

In the method described in FIG. 2, the terminal device detects the wake-up signal, and monitors the PDCCH after the first time point. Therefore, with the method described in FIG. 2, it is beneficial to reducing delay in data transmission and improving data transmission efficiency.

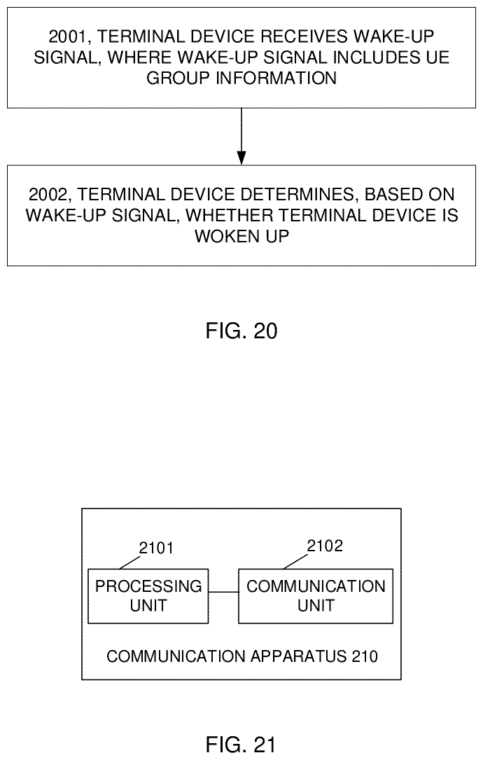

Referring to FIG. 20, FIG. 20 is a flowchart of another method for information processing provided in embodiments of the disclosure. The method for information processing includes step 2001 and step 2002. An execution entity for the method illustrated in FIG. 20 may be a terminal device (for example, that illustrated in FIG. 1), or may be a chip in the terminal device. Exemplarily, the execution entity for the method illustrated in FIG. 20 is a terminal device.

2001, a terminal device receives a wake-up signal, where the wake-up signal includes UE group information.

2002, the terminal device determines, based on the wake-up signal, whether the terminal device is woken up.

In embodiments of the disclosure, the wake-up signal includes the UE group information (i.e. information of a UE group), that is, a sequence of the wake-up signal includes the UE group information. Therefore, by detecting the wake-up signal, the terminal device may determine whether a UE group corresponding to a paging occasion (PO) is waken up, thereby reducing unnecessary power consumption of the terminal device. In addition, since sequences of different random signals may be differentiated based on generators of the sequences of the random signals, the UE group information may also be contained in a generator of the sequence of the wake-up signal. Optionally, the terminal device receives the wake-up signal sent by a network device, where the network device may determine the UE group information based on a higher-layer parameter of a PO.

In a possible implementation, the UE group information includes a UE group identity (ID). The UE group ID is implied in a PO. The PO may be defined as a position in a paging frame (PF), where a system frame number of the PF depends on a first higher-layer parameter, and a position (index) of the PO in the PF depends on a second higher-layer parameter. Therefore, the UE may determine, according to the first higher-layer parameter and the second higher-layer parameter, the system frame number of the PF in which the PO is located and the position (index) of the PO in the PF. In other words, based on the UE group ID, the first higher-layer parameter, and the second higher-layer parameter, the network device and the terminal device may agree on a time (namely, a PO) at which the network device sends a paging message and the terminal device receives the paging message, and the paging message sent by the network device at the PO is specific to a UE group corresponding to the PO. Therefore, the UE group information may be the UE group ID, and similar to the above manner for determining the PO, the UE group ID is obtained according to a UE ID and a higher-layer parameter.

In a possible implementation, the UE group ID is calculated based on the UE ID, the first higher-layer parameter, and the second higher-layer parameter.

In a possible implementation the UE group ID includes a first ID and a second ID. Optionally, the first ID is calculated based on the UE ID and the first higher-layer parameter, and the second ID is calculated based on the UE ID and the second higher-layer parameter. In this way, it is possible to ensure that the UE group is equivalent to a UE group corresponding to a PO.

Optionally, the first ID is a remainder obtained by dividing the UE ID by the first higher-layer parameter, and the second ID is a remainder obtained by dividing the UE ID by the second higher-layer parameter.

Optionally, the UE group ID is a remainder obtained by dividing the UE ID by a target parameter, where the target parameter is a product of the first higher-layer parameter and the second higher-layer parameter.

Optionally, the first higher-layer parameter is a higher-layer parameter that is related to UE subgrouping and used for calculating a PF. The second higher-layer parameter is a higher-layer parameter that is related to UE subgrouping and used for calculating a PO.

In the method illustrated in FIG. 20, the terminal device receives the wake-up signal, where the wake-up signal includes the UE group information. Therefore, with the method described in FIG. 20, whether a UE group corresponding to a PO is woken up can be determined by detecting the wake-up signal, thereby reducing unnecessary power consumption of the terminal device.

Referring to FIG. 21, FIG. 21 is a schematic structural diagram of a communication apparatus according to embodiments of the disclosure. The apparatus may be a terminal device, or an apparatus in the terminal device, or an apparatus that can be matched with the terminal device for use. The communication apparatus 210 illustrated in FIG. 21 may include a processing unit 2101 for data processing and a communication unit 2102. The communication unit 2102 integrates a receiving unit and a sending unit, and may also be referred to as a transceiver unit. Alternatively, the communication unit 2102 may be split into a receiving unit and a sending unit. The processing unit 2101 and the communication unit 2102 below are similar to the processing unit and communication unit described above, and thus will not be described again herein.

The communication unit 2102 is configured to detect a wake-up signal. The communication unit 2102 is configured to monitor a PDCCH after a first time point.

Optionally, in terms of monitoring the PDCCH after the first time point, the communication unit 2102 is specifically configured to: monitor a PDCCH in N slots within a 1^{st} duration that is after the first time point or a PDCCH in a 1^{st} slot within the 1^{st} duration that is after the first time point, where N is a positive integer; or monitor a PDCCH in a 1^{st} slot that is after the first time point.

Optionally, in terms of monitoring the PDCCH after the first time point, the communication unit 2102 is specifically configured to: monitor a PDCCH in W slots within first X durations that are after the first time point or a PDCCH in first X slots that are after the first time point, where X and W each are a positive integer; or monitor a PDCCH in first K slots that are after the first time point, where K is a positive integer.

Optionally, in terms of monitoring the PDCCH after the first time point, the communication unit 2102 is specifically configured to: monitor a PDCCH within a time window that is after the first time point.

Optionally, the first time point equals to a second time point plus a first time interval.

Optionally, the first time interval includes a second time interval plus a time interval related to an SSB period or an SS burst period.

Optionally, the first time interval includes a second time interval plus Y SSB periods, where Y is a positive integer. Alternatively, the first time interval includes a second time interval plus R SSB burst periods, where R is a positive integer.

Optionally, the first time interval includes an interval between a third time point and a slot in which M SSBs or SS bursts closest to the third time point are located, and the third time point equals to the second time point plus a second time interval, where M is a positive integer.

Optionally, the first time interval includes a second time interval plus C SSB periods and D tracking reference signal periods, where C and D each are a positive integer.

Optionally, the first time interval includes an interval between a third time point and a slot in which E SSBs and F tracking reference signals closest to the third time point are located, and the third time point equals to the second time point plus a second time interval, where E and F each are a positive integer.

Optionally, the first time interval includes a second time interval plus a period of a preamble sequence.

Optionally, the first time interval includes an interval between a third time point and a slot in which a preamble sequence closest to the third time point is located, and the third time point equals to the second time point plus a second time interval.

Optionally, the second time point is a position in a sequence of the wake-up signal.

Optionally, the second time point is an ending position of a sequence of the wake-up signal.

Optionally, the second time interval is determined based on a capability of a terminal device.

Optionally, the second time interval is zero.

Optionally, the first time interval is configured via higher-layer signaling.

Optionally, the higher-layer signaling includes SIB signaling or NAS signaling.

The foregoing communication apparatus may be, for example, a chip or a chip module. Each module in various devices or products described in the foregoing embodiments may be a software module or a hardware module, or some may be a software module and the rest may be a hardware module. For example, with regard to various devices or products applied to or integrated into a chip, various modules included therein may all be implemented by means of hardware such as a circuit; or at least some of the modules may be implemented by means of a software program run on a processor integrated in the chip, and the rest (if any) modules may be implemented by means of hardware such as a circuit.

With regard to various devices and products applied to or integrated into a chip module, various modules included therein may all be implemented by means of hardware such as circuit, and different modules may be located in the same component (e.g. chip, circuit module, etc.) or different components of the chip module. Alternatively, at least some of the modules may be implemented by means of a software program run on a processor integrated into the chip module, and the rest (if any) of the modules may be implemented by means of hardware such as circuit. With regard to various devices and products applied to or integrated into a terminal, various modules included therein may all be implemented by means of hardware such as circuit, and different modules may be located in the same component (e.g. chip, circuit module, etc.) or different components of the terminal. Alternatively, at least some of the modules may be implemented by means of a software program run on a processor integrated into the terminal, and the rest (if any) of the modules may be implemented by means of hardware such as circuit.

Referring to FIG. 21, FIG. 21 is a schematic structural diagram of a communication apparatus according to embodiments of the disclosure. The apparatus may be a terminal device, or an apparatus in the terminal device, or an apparatus that can be matched with the terminal device for use. The communication apparatus 210 illustrated in FIG. 21 may include a processing unit 2101 for data processing and a communication unit 2102. The communication unit 2102 integrates a receiving unit and a sending unit, and may also be referred to as a transceiver unit. Alternatively, the communication unit 2102 may be split into a receiving unit and a sending unit. The processing unit 2101 and the communication unit 2102 below are similar to the processing unit and communication unit described above, and thus will not be described again herein.

The communication unit 2102 is configured to receive a wake-up signal, where the wake-up signal includes UE group information.

Optionally, the UE group information includes a UE group ID.

Optionally, the UE group ID is calculated based on a UE ID, a first higher-layer parameter, and a second higher-layer parameter.

Optionally, the UE group ID includes a first ID and a second ID.

Optionally, the first ID is calculated based on a UE ID and a first higher-layer parameter. The second ID is calculated based on the UE ID and a second higher-layer parameter.

Optionally, the first ID is a remainder obtained by dividing a UE ID by a first higher-layer parameter. The second ID is a remainder obtained by dividing the UE ID by a second higher-layer parameter.

Optionally, the UE group ID is a remainder obtained by dividing a UE ID by a target parameter, and the target parameter is a product of a first higher-layer parameter and a second higher-layer parameter.

Optionally, the first higher-layer parameter is a higher-layer parameter that is related to UE subgrouping and used for calculating a PF.

Optionally, the second higher-layer parameter is a higher-layer parameter that is related to UE subgrouping and used for calculating a PO.

The foregoing communication apparatus may be, for example, a chip or a chip module. Each module in various devices or products described in the foregoing embodiments may be a software module or a hardware module, or some may be a software module and the rest may be a hardware module. For example, with regard to various devices or products applied to or integrated into a chip, various modules included therein may all be implemented by means of hardware such as a circuit; or at least some of the modules may be implemented by means of a software program run on a processor integrated in the chip, and the rest (if any) modules may be implemented by means of hardware such as a circuit. With regard to various devices and products applied to or integrated into a chip module, various modules included therein may all be implemented by means of hardware such as circuit, and different modules may be located in the same component (e.g. chip, circuit module, etc.) or different components of the chip module. Alternatively, at least some of the modules may be implemented by means of a software program run on a processor integrated into the chip module, and the rest (if any) of the modules may be implemented by means of hardware such as circuit. With regard to various devices and products applied to or integrated into a terminal, various modules included therein may all be implemented by means of hardware such as circuit, and different modules may be located in the same component (e.g. chip, circuit module, etc.) or different components of the terminal. Alternatively, at least some of the modules may be implemented by means of a software program run on a processor integrated into the terminal, and the rest (if any) of the modules may be implemented by means of hardware such as circuit.

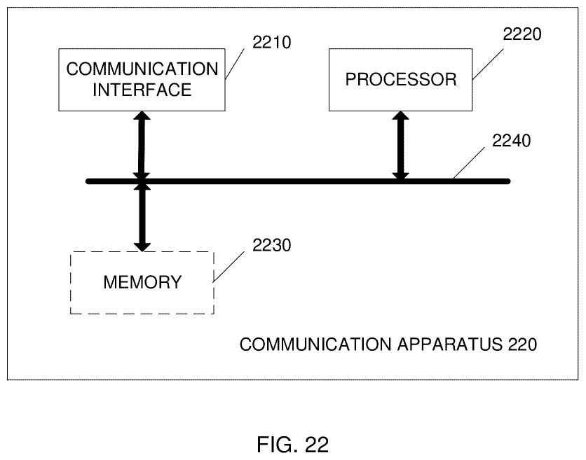

FIG. 22 illustrates another communication apparatus 220 provided in embodiments of the disclosure. The communication apparatus 220 is configured to implement functions of the terminal device illustrated in FIG. 2 and FIG. 20. The apparatus may be a terminal device or an apparatus in terminal device. The apparatus in the terminal device may be an SOC or a chip in the terminal device. The SOC may be constituted by a chip, or may include a chip and other discrete components.

The communication apparatus 220 includes at least one processor 2220. The processor 2220 is configured to implement data processing functions of the terminal device in the method provided in embodiments of the disclosure. The communication apparatus 220 may further include a communication interface 2210. The communication interface 2210 is configured to implement receiving and sending operations of the terminal device in the method provided in embodiments of the disclosure. In embodiments of the disclosure, the communication interface may be a transceiver, a circuit, a bus, a module, or other types of communication interface and are used for communicating with other devices over a transmission medium. For example, the communication interface 2210 is configured for an apparatus in the communication apparatus 220 to communicate with other devices. The processor 2220 is configured to receive and transmit data via the communication interface 2210, and implement the method described in method embodiments illustrated in FIG. 2.

The communication device 220 may further include at least one memory 2230. The memory 2230 is configured to store program instructions and/or data. The memory 2230 is coupled to the processor 2220. The coupling in embodiments of the disclosure is indirect coupling or communication connection between apparatuses, units, or modules, and may be electrical, mechanical, or otherwise in order for information exchange between the apparatuses, units, or modules. The processor 2220 may cooperate with the memory 2230. The processor 2220 may execute the program instructions stored in the memory 2230. At least one of the at least one memory may be integrated into the processor.

After the communication apparatus 220 is powered on, the processor 2220 may read software programs in the memory 2230, interpret and execute instructions of the software programs, and process data of the software programs. When data needs to be sent in a wireless manner, after performing baseband processing on the data to be sent, the processor 2220 outputs a baseband signal to a radio frequency circuit (not illustrated in the figure); and after performing radio frequency processing on the baseband signal, the radio frequency circuit sends a radio frequency signal outwards in the form of electromagnetic wave through an antenna. When data is sent to the communication apparatus 220, the radio frequency circuit receives a radio frequency signal through an antenna, converts the radio frequency signal into a baseband signal, and outputs the baseband signal to the processor 2220; and the processor 2220 converts the baseband signal into data and processes the data.

In another implementation, the radio frequency circuit and the antenna may be disposed separately from the processor 2220 for performing baseband processing. For example, in a distributed scenario, the radio frequency circuit and the antenna may be disposed in a remote layout separately from the communication apparatus.

There is no limitation on the connection medium between the communication interface 2210, the processor 2220, and the memory 2230 above in embodiments of the disclosure. In embodiments of the disclosure, in FIG. 22, the memory 2230, the processor 2220, and the communication interface 2210 are connected via a bus 2240, where the bus is illustrated by a bold line in FIG. 22. The connection manner between other components is only illustrative and is not limited thereto. The bus may be classified into an address bus, a data bus, a control bus, and the like. For the convenience of illustration, the bus is illustrated by only one bold line in FIG. 22, but it does not mean that there is only one bus or one type of bus.

When the communication apparatus 220 is specifically used in a terminal device, for example, when the communication apparatus 220 is specifically a chip or an SOC, a baseband signal may be output or received by the communication interface 2210. When the communication apparatus 220 is specifically a terminal device, a radio frequency signal may be output or received by the communication interface 2210. In embodiments of the disclosure, the processor may be a general-purpose processor, a digital signal processor, an application-specific integrated circuit, a field programmable gate array, or other programmable logic devices, a discrete gate or transistor logic device, or a discrete hardware component, and may implement or execute the methods, operations, and logic block diagrams disclosed in embodiments of the disclosure. The general-purpose processor may be a microprocessor or any conventional processor. The operations of the methods disclosed in embodiments of the disclosure may be directly implemented by a hardware processor, or implemented by a combination of hardware and software modules in the processor.

It should be noted that, the communication apparatus may perform steps related to the terminal device or the access-network device in the foregoing method embodiments. For details thereof, reference can be made to the implementations provided in the foregoing steps, which will not be described again herein.

With regard to various devices and products applied to or integrated into the communication apparatus, various modules included therein may all be implemented by means of hardware such as circuit, and different modules may be located in the same component (for example, a chip, a circuit module, and so on) or different components in the terminal. Alternatively, at least some of the modules may be implemented by means of software programs run on a processor integrated into the terminal, and the rest (if any) of the modules may be implemented by means of hardware such as circuit.

Embodiments of the disclosure further provide a chip. The chip includes a processor and a communication interface. The processor is configured to: detect a wake-up signal, and monitor a PDCCH after a first time point.

Optionally, in terms of monitoring the PDCCH after the first time point, the chip is specifically configured to: monitor a PDCCH in N slots within a 1^{st} duration that is after the first time point or a PDCCH in a 1^{st} slot within the 1^{st} duration that is after the first time point, where N is a positive integer; or monitor a PDCCH in a 1^{st} slot that is after the first time point.

Optionally, in terms of monitoring the PDCCH after the first time point, the chip is specifically configured to: monitor a PDCCH in W slots within first X durations that are after the first time point or a PDCCH in first X slots that are after the first time point, where X and W each are a positive integer; or monitor a PDCCH in first K slots that are after the first time point, where K is a positive integer.

Optionally, in terms of monitoring the PDCCH after the first time point, the chip is specifically configured to: monitor a PDCCH within a time window that is after the first time point.

Optionally, the first time point equals to a second time point plus a first time interval.

Optionally, the first time interval includes a second time interval plus a time interval related to an SSB period or an SS burst period.

Optionally, the first time interval includes a second time interval plus Y SSB periods, where Y is a positive integer. Alternatively, the first time interval includes a second time interval plus R SSB burst periods, where R is a positive integer.

Optionally, the first time interval includes an interval between a third time point and a slot in which M SSBs or SS bursts closest to the third time point are located, and the third time point equals to the second time point plus a second time interval, where M is a positive integer.

Optionally, the first time interval includes a second time interval plus C SSB periods and D tracking reference signal periods, where C and D each are a positive integer.

Optionally, the first time interval includes an interval between a third time point and a slot in which E SSBs and F tracking reference signals closest to the third time point are located, and the third time point equals to the second time point plus a second time interval, where E and F each are a positive integer.

Optionally, the first time interval includes a second time interval plus a period of a preamble sequence.

Optionally, the first time interval includes an interval between a third time point and a slot in which a preamble sequence closest to the third time point is located, and the third time point equals to the second time point plus a second time interval.

Optionally, the second time point is a position in a sequence of the wake-up signal.

Optionally, the second time point is an ending position of a sequence of the wake-up signal.

Optionally, the second time interval is determined based on a capability of a terminal device.

Optionally, the second time interval is zero.

Optionally, the first time interval is configured via higher-layer signaling.

Optionally, the higher-layer signaling includes SIB signaling or NAS signaling.

In a possible implementation, the chip includes at least one processor, at least one first memory, and at least one second memory. The at least one first memory and the at least one processor are connected with each other via a line, and the first memory is configured to store instructions. The at least one second memory and the at least one processor are connected with each other via a line, and the second memory is configured to store data that needs to be stored in the method embodiments.

With regard to various devices and products applied to or integrated into the chip, various modules included therein may all be implemented by means of hardware such as circuit. Alternatively, at least some of the modules may be implemented by means of software programs run on a processor integrated into the chip, and the rest (if any) of the modules may be implemented by means of hardware such as circuit.

Embodiments of the disclosure further provide a chip. The chip includes a processor and a communication interface. The processor is configured to: receive a wake-up signal, where the wake-up signal includes UE group information.

Optionally, the UE group information includes a UE group ID.

Optionally, the UE group ID is calculated based on a UE ID, a first higher-layer parameter, and a second higher-layer parameter.

Optionally, the UE group ID includes a first ID and a second ID.

Optionally, the first ID is calculated based on a UE ID and a first higher-layer parameter. The second ID is calculated based on the UE ID and a second higher-layer parameter.

Optionally, the first ID is a remainder obtained by dividing a UE ID by a first higher-layer parameter. The second ID is a remainder obtained by dividing the UE ID by a second higher-layer parameter.

Optionally, the UE group ID is a remainder obtained by dividing a UE ID by a target parameter, and the target parameter is a product of a first higher-layer parameter and a second higher-layer parameter.

Optionally, the first higher-layer parameter is a higher-layer parameter that is related to UE subgrouping and used for calculating a PF.

Optionally, the second higher-layer parameter is a higher-layer parameter that is related to UE subgrouping and used for calculating a PO.

In a possible implementation, the chip includes at least one processor, at least one first memory, and at least one second memory. The at least one first memory and the at least one processor are connected with each other via a line, and the first memory is configured to store instructions. The at least one second memory and the at least one processor are connected with each other via a line, and the second memory is configured to store data that needs to be stored in the method embodiments.

With regard to various devices and products applied to or integrated into the chip, various modules included therein may all be implemented by means of hardware such as circuit. Alternatively, at least some of the modules may be implemented by means of software programs run on a processor integrated into the chip, and the rest (if any) of the modules may be implemented by means of hardware such as circuit.

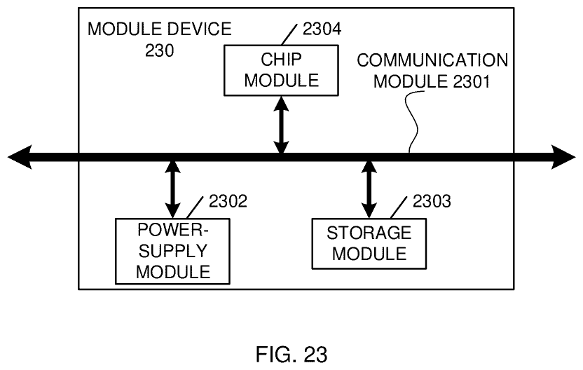

As illustrated in FIG. 23, FIG. 23 is a schematic structural diagram of a module device provided in embodiments of the disclosure. The module device 230 may perform steps related to the terminal device in the foregoing method embodiments. The module device 230 includes a communication module 2301, a power-supply module 2302, a storage module 2303, and a chip module 2304.

The power-supply module 2302 is configured to supply electric energy to the module device. The storage module 2303 is configured to store data and instructions. The communication module 2301 is configured to perform internal communication within the module device or communication between the module device and an external device. The chip module 2304 is configured to trigger the communication module to detect a wake-up signal, and trigger the communication module to monitor a PDCCH after a first time point.

Optionally, in terms of monitoring the PDCCH after the first time point, the chip module 2304 is specifically configured to: monitor a PDCCH in N slots within a 1^{st} duration that is after the first time point or a PDCCH in a 1^{st} slot within the 1^{st} duration that is after the first time point, where N is a positive integer; or monitor a PDCCH in a 1^{st} slot that is after the first time point.

Optionally, in terms of monitoring the PDCCH after the first time point, the chip module 2304 is specifically configured to: monitor a PDCCH in Wslots within first X durations that are after the first time point or a PDCCH in first X slots that are after the first time point, where X and Weach are a positive integer; or monitor a PDCCH in first K slots that are after the first time point, where K is a positive integer.

Optionally, in terms of monitoring the PDCCH after the first time point, the chip module 2304 is specifically configured to: monitor a PDCCH within a time window that is after the first time point.

Optionally, the first time point equals to a second time point plus a first time interval.

Optionally, the first time interval includes a second time interval plus a time interval related to an SSB period or an SS burst period.

Optionally, the first time interval includes a second time interval plus Y SSB periods, where Y is a positive integer. Alternatively, the first time interval includes a second time interval plus R SSB burst periods, where R is a positive integer.

Optionally, the first time interval includes an interval between a third time point and a slot in which M SSBs or SS bursts closest to the third time point are located, and the third time point equals to the second time point plus a second time interval, where M is a positive integer.

Optionally, the first time interval includes a second time interval plus C SSB periods and D tracking reference signal periods, where C and Deach are a positive integer.

Optionally, the first time interval includes an interval between a third time point and a slot in which E SSBs and F tracking reference signals closest to the third time point are located, and the third time point equals to the second time point plus a second time interval, where E and F each are a positive integer.

Optionally, the first time interval includes a second time interval plus a period of a preamble sequence.

Optionally, the first time interval includes an interval between a third time point and a slot in which a preamble sequence closest to the third time point is located, and the third time point equals to the second time point plus a second time interval.

Optionally, the second time point is a position in a sequence of the wake-up signal.

Optionally, the second time point is an ending position of a sequence of the wake-up signal.

Optionally, the second time interval is determined based on a capability of a terminal device.

Optionally, the second time interval is zero.

Optionally, the first time interval is configured via higher-layer signaling.

Optionally, the higher-layer signaling includes SIB signaling or NAS signaling. With regard to various devices and products applied to or integrated into the chip module, various modules included therein may all be implemented by means of hardware such as circuit, and different modules may be located in the same component (for example, a chip, a circuit module, and so on) or different components in the chip module. Alternatively, at least some of the modules may be implemented by means of software programs run on a processor integrated into the chip module, and the rest (if any) of the modules may be implemented by means of hardware such as circuit. Embodiments of the disclosure further provide a computer-readable storage medium. The computer-readable storage medium stores instructions which, when executed by a processor, are operable to implement the method flows of the foregoing method embodiments.

As illustrated in FIG. 23, FIG. 23 is a schematic structural diagram of a module device provided in embodiments of the disclosure. The module device 230 may perform steps related to the terminal device in the foregoing method embodiments. The module device 230 includes a communication module 2301, a power-supply module 2302, a storage module 2303, and a chip module 2304.

The power-supply module 2302 is configured to supply electric energy to the module device. The storage module 2303 is configured to store data and instructions. The communication module 2301 is configured to perform internal communication within the module device or communication between the module device and an external device. The chip module 2304 is configured to trigger the communication module to receive a wake-up signal, where the wake-up signal includes UE group information.

Optionally, the UE group information includes a UE group ID.

Optionally, the UE group ID is calculated based on a UE ID, a first higher-layer parameter, and a second higher-layer parameter.

Optionally, the UE group ID includes a first ID and a second ID.

Optionally, the first ID is calculated based on a UE ID and a first higher-layer parameter. The second ID is calculated based on the UE ID and a second higher-layer parameter.

Optionally, the first ID is a remainder obtained by dividing an UE ID by a first higher-layer parameter. The second ID is a remainder obtained by dividing the UE ID by a second higher-layer parameter.

Optionally, the UE group ID is a remainder obtained by dividing a UE ID by a target parameter, and the target parameter is a product of a first higher-layer parameter and a second higher-layer parameter.

Optionally, the first higher-layer parameter is a higher-layer parameter that is related to UE subgrouping and used for calculating a PF.

Optionally, the second higher-layer parameter is a higher-layer parameter that is related to UE subgrouping and used for calculating a PO.

With regard to various devices and products applied to or integrated into the chip module, various modules included therein may all be implemented by means of hardware such as circuit, and different modules may be located in the same component (for example, a chip, a circuit module, and so on) or different components in the chip module. Alternatively, at least some of the modules may be implemented by means of software programs run on a processor integrated into the chip module, and the rest (if any) of the modules may be implemented by means of hardware such as circuit. Embodiments of the disclosure further provide a computer-readable storage medium. The computer-readable storage medium stores instructions which, when executed by a processor, are operable to implement the method flows of the foregoing method embodiments.

With regard to various devices and products applied to or integrated into the chip module, various modules included therein may all be implemented by means of hardware such as circuit, and different modules may be located in the same component (for example, a chip, a circuit module, and so on) or different components in the chip module. Alternatively, at least some of the modules may be implemented by means of software programs run on a processor integrated into the chip module, and the rest (if any) of the modules may be implemented by means of hardware such as circuit. Embodiments of the disclosure further provide a computer-readable storage medium. The computer-readable storage medium stores instructions which, when executed by a processor, are operable to implement the method flows of the foregoing method embodiments.

Embodiments of the disclosure further provide a computer program product. The computer program product, when executed by a processor, is operable to implement the method flows of the foregoing method embodiments.

It should be noted that, for the sake of brevity, various method embodiments above are described as a series of action combinations. However, it will be appreciated by those skilled in the art that the disclosure is not limited by the sequence of actions described. According to the disclosure, some steps may be performed in other orders or simultaneously. In addition, it will be appreciated by those skilled in the art that the embodiments described in the specification are preferable embodiments, and the actions and modules involved are not necessarily essential to the disclosure.

Reference can be made between elaborations of the embodiments provided in the disclosure, and elaboration of each embodiment has its own emphasis. For the part not described in detail in an embodiment, reference can be made to related elaborations of other embodiments. For convenience and brevity of illustration, for example, with regard to functions and operations performed by various apparatuses and devices provided in embodiments of the disclosure, reference can be made to related elaborations in the method embodiments of the disclosure. Reference or combination may be made between the method embodiments and between the apparatus embodiments.

Finally, it should be noted that, the foregoing embodiments are merely intended for describing the technical solutions of the disclosure rather than limiting the disclosure. Although the disclosure is described in detail with reference to the foregoing embodiments, those of ordinary skill in the art should understand that they may still make modifications to the technical solutions described in the foregoing embodiments or make equivalent replacements to some or all technical features thereof, and such modifications or replacements do not make the essence of the corresponding technical solutions depart from the scope of the technical solutions of the embodiments of the disclosure.

1. A method for information processing, comprising:
detecting a wake-up signal; and
monitoring a physical downlink control channel (PDCCH) after a first time point.

2. The method of claim 1, wherein monitoring the PDCCH after the first time point comprises:
monitoring a PDCCH in N slots within a 1^{st} duration that is after the first time point, wherein N is a positive integer; or
monitoring a PDCCH in a 1^{st} slot that is after the first time point; or
monitoring a PDCCH in W slots within first X durations that are after the first time point, wherein X and W each are a positive integer; or
monitoring a PDCCH in first K slots that are after the first time point, wherein K is a positive integer.

3. (canceled)

4. The method of claim 1, wherein monitoring the PDCCH after the first time point comprises:
monitoring a PDCCH within a time window that is after the first time point.

5. The method of claim 1, wherein the first time point equals to a second time point plus a first time interval.

6. The method of claim 5, wherein the first time interval comprises a second time interval plus a time interval related to a synchronization signal (SS)/physical broadcast channel (PBCH) block (SSB) period or an SS burst period; or
the first time interval comprises a second time interval plus Y SSB periods, wherein Y is a positive integer; or the first time interval comprises a second time interval plus R SSB burst periods, wherein R is a positive integer; or
the first time interval comprises an interval between a third time point and a slot in which M SSBs or SS bursts closest to the third time point are located, and the third time point equals to the second time point plus a second time interval, wherein M is a positive integer.

7. (canceled)

8. (canceled)

9. (canceled)

10. (canceled)

11. The method of claim 5, wherein the first time interval comprises a second time interval plus a period of a preamble sequence; or the first time interval comprises an interval between a third time point and a slot in which a preamble sequence closest to the third time point is located, and the third time point equals to the second time point plus a second time interval.

12. (canceled)

13. The method of claim 5, wherein the second time point is a position in a sequence of the wake-up signal, or the second time point is an ending position of a sequence of the wake-up signal.

14. (canceled)

15. The method of claim 6, wherein the second time interval is determined based on a capability of a terminal device, or the second time interval is zero.

16. (canceled)

17. The method of claim 5, wherein the first time interval is configured via higher-layer signaling.

18. (canceled)

19. A method for information processing, comprising:
receiving a wake-up signal, wherein the wake-up signal comprises user equipment (UE) group information.

20. The method of claim 19, wherein the UE group information comprises a UE group identity (ID).

21. The method of claim 20, wherein the UE group ID is calculated based on a UE ID, a first higher-layer parameter, and a second higher-layer parameter.

22. The method of claim 20, wherein the UE group ID comprises a first ID and a second ID.

23. The method of claim 22, wherein
the first ID is calculated based on a UE ID and a first higher-layer parameter;
the second ID is calculated based on the UE ID and a second higher-layer parameter.

24. The method of claim 22, wherein
the first ID is a remainder obtained by dividing a UE ID by a first higher-layer parameter;
the second ID is a remainder obtained by dividing the UE ID by a second higher-layer parameter.

25. The method of claim 20, wherein the UE group ID is a remainder obtained by dividing a UE ID by a target parameter, and the target parameter is a product of a first higher-layer parameter and a second higher-layer parameter.

26. (canceled)

27. (canceled)

28. (canceled)

29. A communication apparatus, comprising:
a memory configured to store computer programs;
a processor configured to invoke the computer programs from the memory to execute;
detecting a wake-up signal; and
monitoring a physical downlink control channel (PDCCH) after a first time point.

30-35. (canceled)

36. The communication apparatus of claim 29, wherein the processor configured to execute monitoring the PDCCH after the first time point is configured to execute:
monitoring a PDCCH in N slots within a 1^{st} duration that is after the first time point, wherein N is a positive integer; or
monitoring a PDCCH in a 1^{st} slot that is after the first time point; or
monitoring a PDCCH in W slots within first X durations that are after the first time point, wherein X and W each are a positive integer; or
monitoring a PDCCH in first K slots that are after the first time point, wherein K is a positive integer.

37. The communication apparatus of claim 29, wherein the processor configured to execute monitoring the PDCCH after the first time point is configured to execute:
monitoring a PDCCH within a time window that is after the first time point.

38. The communication apparatus of claim 29, wherein the first time point equals to a second time point plus a first time interval.
